(19) United States
(12) Patent Application Publication
(10) Pub. No.: US 2005/0206228 A1
(43) Pub. Date: Sep. 22, 2005

(54) Brake control for vehicle

(75) Inventor: Nobuyuki Ohtsu, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: HITACHI, LTD.

(21) Appl. No.: 11/079,201

(22) Filed: Mar. 15, 2005

(30) Foreign Application Priority Data
Mar. 17, 2004 (JP) 2004-007114

(51) Int. Cl. B60T 8/36

(52) U.S. Cl. 303/119.1; 303/156; 303/157

(57) ABSTRACT

A brake control apparatus for a vehicle, includes a brake actuator, a solenoid valve to regulate a brake fluid pressure supplied to the brake actuator, a condition sensor to sense a vehicle running condition; and a brake control section to control the brake fluid pressure in a pressure decrease mode and a pressure increase mode in accordance with the vehicle running condition, by controlling the solenoid valve. The brake control section monitors a cycle time of a cycle from a first pressure decrease operation to a second pressure decrease operation of the solenoid valve and a pressure increase time spent to control the solenoid valve in the pressure increase mode within the cycle, and determines a solenoid valve drive time corresponding to the pressure increase mode in a next cycle, in accordance with the cycle time and the pressure increase time.

### BACKGROUND OF THE INVENTION

The present invention relates to technique of brake control for wheeled vehicle, and to technique of preventing wheel locking on braking with one or more solenoid valves.

A Published Japanese Patent Application Publication No.2000-255407 shows a brake control system arranged to control a solenoid valve with a PWM signal to increase, hold and decrease a brake pressure in a wheel cylinder for each wheel. To prevent undesired influence on vehicle's behavior by errors in operating quantities of solenoid valves, this system varies a duty ratio of a PWM signal to each solenoid valve by monitoring variation of a wheel cylinder pressure.

A Published Japanese Patent Application Publication No.H09-104336 shows an anti-skid brake control system to control the duty ratio of a PWM signal in accordance with a number of pulses corresponding to pressure increasing operations.

### SUMMARY OF THE INVENTION

The brake control system of the first Japanese patent document No.2000-255407 makes correction in accordance with the wheel cylinder pressure, without consideration for nonuniformity in response characteristic of solenoid valves due to nonuniformity in pressure sensing devices or in pressure estimation, so that the improvement in control accuracy is limited. The brake control system of the second Japanese patent document No. H09-104336 determines the pressure increase quantity in a currently cycle without sufficient information as to whether the pressure increase quantity in the most recent cycle is excessive or deficient.

According to one aspect of the present invention, a brake control apparatus for a vehicle, comprises: a hydraulic brake actuator to brake a wheel of the vehicle; a solenoid valve to regulate a brake fluid pressure supplied to the brake actuator; a condition sensor to sense a vehicle running condition; and a brake control section to control the brake fluid pressure for the hydraulic brake actuator in a pressure decrease mode and a pressure increase mode in accordance with the vehicle operating condition sensed by the condition sensor, by controlling the solenoid valve. The brake control section is configured to monitor a cycle time of a cycle from a first pressure decrease operation to a second pressure decrease operation of the solenoid valve and a pressure increase time spent to control the solenoid valve in the pressure increase mode within the cycle, and to determine a solenoid valve drive time corresponding to the pressure increase mode in a next cycle, in accordance with the cycle time and the pressure increase time.

According to another aspect of the invention, a brake control apparatus for a vehicle, comprises: means for driving a solenoid valve to control a brake fluid pressure supplied to a wheel cylinder of the vehicle, and for thereby performing pressure decrease control and pressure increase control; means for monitoring a pressure increase time which is a length of time of the pressure increase control in a cycle between two consecutive pressure decrease operations for the pressure decrease control; and means for controlling a solenoid valve drive time to drive the solenoid valve to increase the brake fluid pressure, in accordance with the pressure increase time.

### BRIEF DESCRIPTION OF THE DRAWINGS

FIG. 1 is a schematic view showing a basic arrangement according to a first embodiment of the present invention.

FIG. 2 is a diagram of a brake fluid pressure hydraulic circuit in a brake control system according to the first embodiment of the present invention.

FIG. 3 is a block diagram showing a control unit in the brake control system of FIG. 2.

FIG. 4 is a flowchart showing a basic control process performed by the control unit of FIG. 3.

FIG. 5 is a flowchart showing the calculation of a pseudo vehicle body speed in the control process of FIG. 4.

FIG. 6 is a flowchart showing the calculation of a vehicle body deceleration in the control process of FIG. 4.

FIG. 7 is a flowchart showing the process of determination of a PWM duty in the control process of FIG. 4.

FIG. 8A is a flowchart showing a duty learning control based on a cycle time, used in the process of FIG. 7. FIG. 8B is a flowchart showing a duty learning control based on a pressure increase time, used in the process of FIG. 7.

FIG. 9 is a flowchart showing the calculation of a control target speed in the control process of FIG. 4.

FIG. 10 is a flowchart showing the process of PI control in the control process of FIG. 4.

FIG. 11 is a flowchart of a pressure decrease control in the control process of FIG. 4.

FIG. 12 is a flowchart of a pressure increase control in the control process of FIG. 4.

FIG. 13 is a flowchart of a port pressure increase output INCT increment process in the control process of FIG. 12.

FIG. 14 is a flowchart of a pressure hold output INCT decrement process in the control process of FIG. 12.

FIG. 15 is a flowchart of a PWM timer reset process in the first embodiment.

FIG. 16 is a time chart illustrating a solenoid signal and a control cycle time used in the brake control system according to the first embodiment.

FIG. 17 is a schematic view illustrating movement in a pressure increase valve used in the first embodiment.

FIG. 18 is a view illustrating a relation between the PWM pressure increase control and the movement in the solenoid valve in the first embodiment.

### DETAILED DESCRIPTION OF THE INVENTION

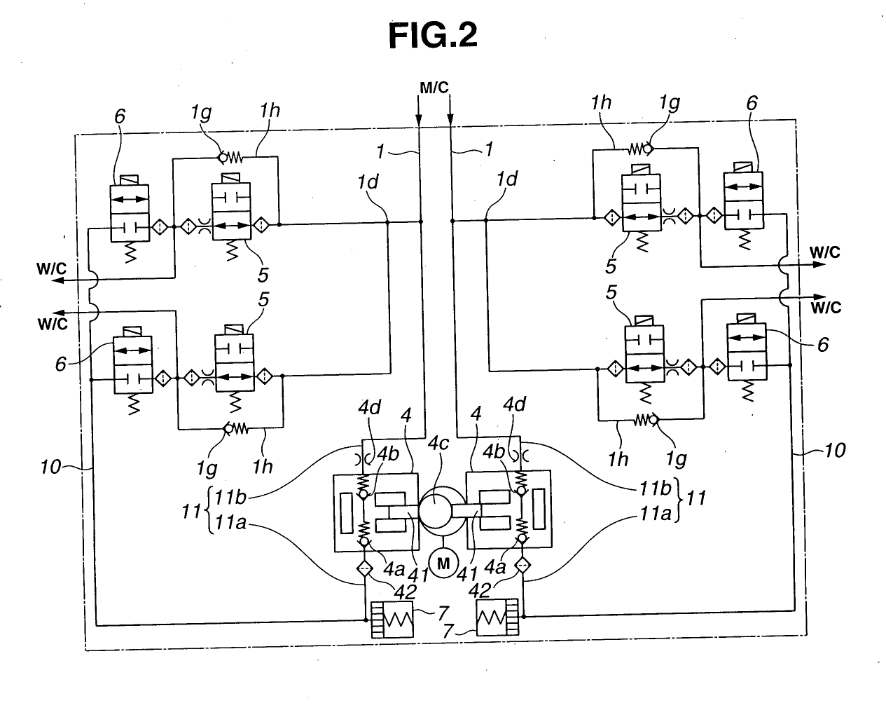

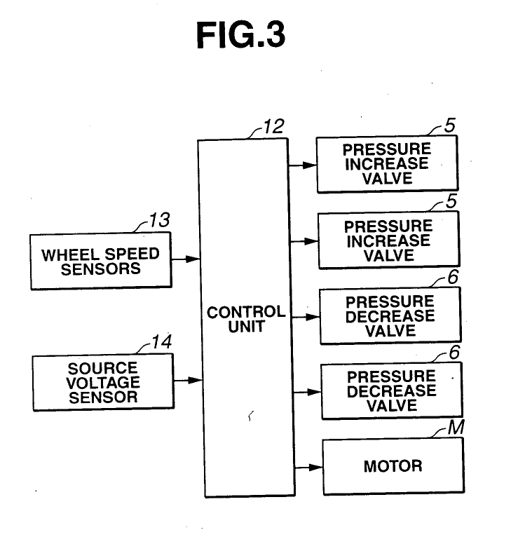

FIGS. 2 and 3 show a brake control system according to one embodiment of the present invention. As shown in FIG. 2, a master cylinder M/C is connected to four wheel cylinders W/C for four wheels of a vehicle, through two brake circuits 1 and 1.

Each brake circuit 1 has two branch circuits branching off at a branch point 1d. Each branch circuit includes a pressure increase valve 5 disposed on a downstream side (or wheel cylinder's side) of branch point 1d. Each pressure increase valve 5 is a normally open, two-port-two-position, on-off solenoid valve which is normally held open by a spring force in an inoperative (deenergized) state, and closed in an operative (energized) state.

A bypass line 1h having a one-way valve (or check valve) 1g is connected in parallel to each pressure increase valve 5, and arranged to return a brake pressure smoothly from a corresponding one of the wheel cylinders W/C when a braking operation is ended. Each one-way valve 1g is arranged to allow a returning flow of the brake fluid through the corresponding bypass line 1h only in one direction from the downstream (wheel cylinder's) side to the upstream (master cylinder's) side.

A pressure decrease valve 6 is provided on the downstream side of each pressure increase valve 5, and connected to a reservoir 7 through a drain circuit 10. Each pressure decrease valve 6 is a normally closed, two-port-two-position, on-off solenoid valve which is normally held closed in an inoperative (deenergized) state, and opened in an operative (energized) state.

A return circuit 11 connects the drain circuit 10 to an upstream circuit section on the upstream side of the branch point 1d. A pump 4 is disposed in the return circuit 11 and arranged to return the brake fluid stored in the reservoir 7 to the upstream circuit section on the upstream side of the branch point 1d. The return circuit 11 includes an intake circuit 11a and a discharge circuit 11b.

The pump 4 of each return circuit 11 is arranged to suck the brake fluid from intake circuit 11a and to discharge the brake fluid to discharge circuit 11b by reciprocating motion of a plunger 41. The plungers 41 of the two return circuits 11 confront each other across a cam 4c driven by a motor M, as shown in FIG. 2. The cam 4c forces the plungers 41 on both sides back and forth. On each side, there are provided an intake valve 4a and a discharge valve 4b for preventing a flow in a reverse direction; a filter 42 on the intake side, and a damper 4d for absorbing pulsation on the discharge side.

When a locking tendency of a wheel is increased during braking, the thus-constructed brake system performs an anti-skid (or anti-lock) brake control for preventing wheel locking and braking the vehicle adequately, by repeating a pressure decrease control and a pressure increase control, and adding a pressure hold control as appropriate. In the pressure decrease control, the brake control system decreases the brake fluid pressure by closing the pressure increase valve 5 in the circuit connected to the wheel cylinder of the wheel exhibiting an increased locking tendency, and opening the pressure decrease valve 6 to drain the brake fluid from the wheel cylinder W/C to the reservoir 7. In the pressure increase control, the brake control system supplies the master cylinder pressure to the wheel cylinder W/C and thereby increases the brake fluid pressure, by restoring the pressure increase valve 5 to the open state, and closing the pressure decrease valve 6. The pressure hold control is performed by closing both the pressure increase valve 5 and pressure decrease valve 6.

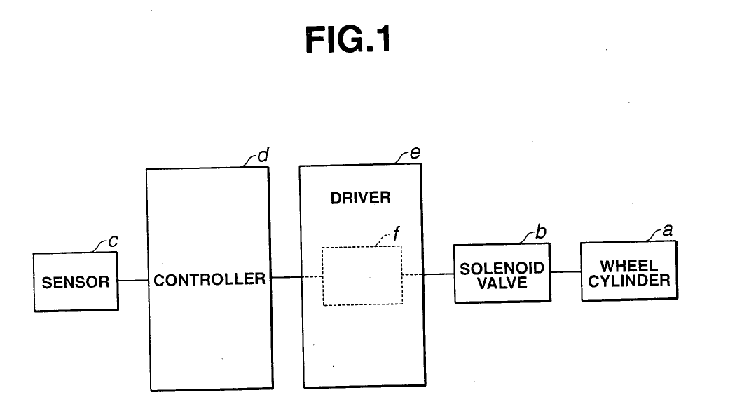

A control unit 12 shown in FIG. 3 performs the anti-skid control. Control unit 12 is connected, on the input side, with wheel speed sensors 13 for sensing the wheel speeds of the front left and right wheels and the rear left and right wheels, and a source voltage sensor 14 for sensing a source voltage; and further connected, on the output side, with the pressure increase valve 5 and decrease valve 6 for each wheel, and the motor M. Control unit 12 of this example includes a controller section “d” and a driver section “e” as shown in FIG. 1.

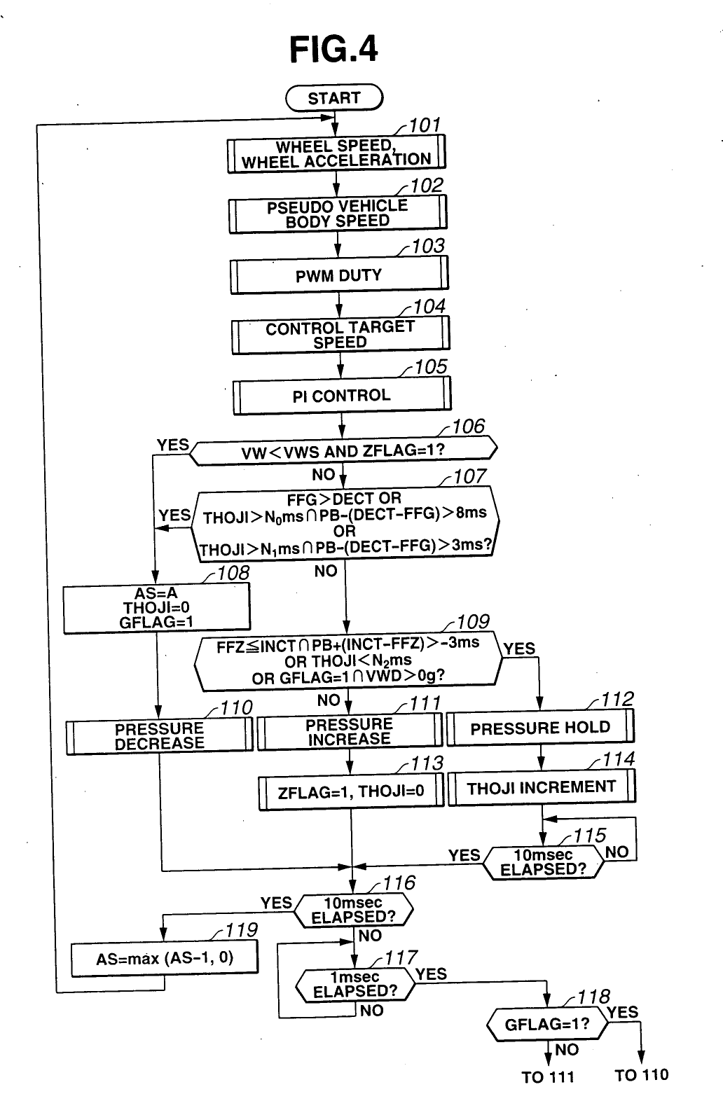

FIG. 4 shows a base control flow of an anti-skid brake control process performed by control unit 12. This anti-skid brake control process is performed periodically at regular intervals of 10 msec.

Step 101 determines a sensor frequency from the period and the number of pulses produced by each wheel speed sensor 13 at intervals of 10 ms, and calculates a wheel speed VW and a wheel acceleration ΔVW of each wheel from the sensor frequency. In the following description and drawings, a subscript FR, FL, RR or RL added to VW or ΔVW indicates the wheel speed or acceleration of a corresponding one of the front right and left wheels FR and FL and the rear right and left wheels RR and RL. XX indicates any one of the four wheels FR, FL, RR and RL.

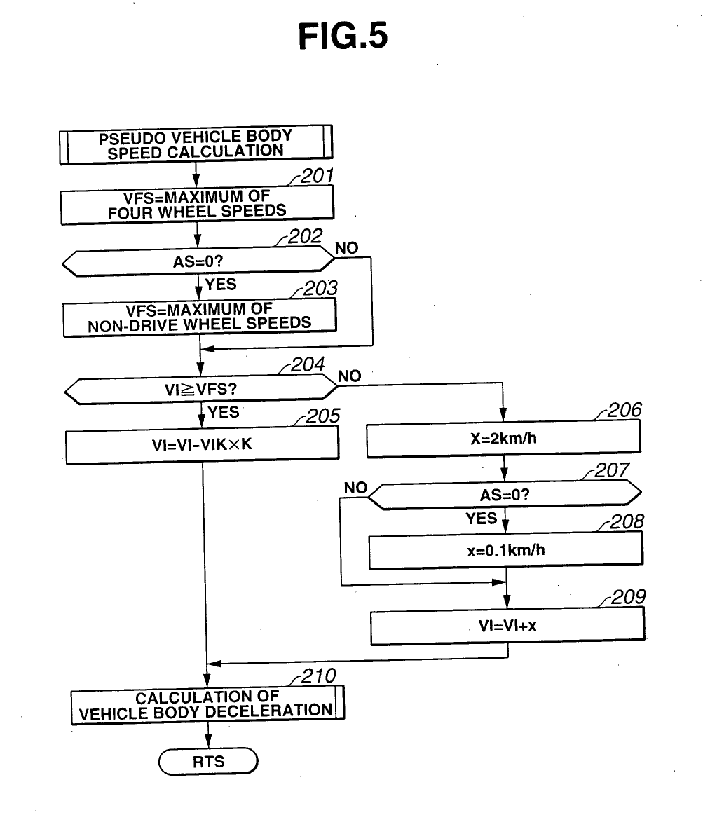

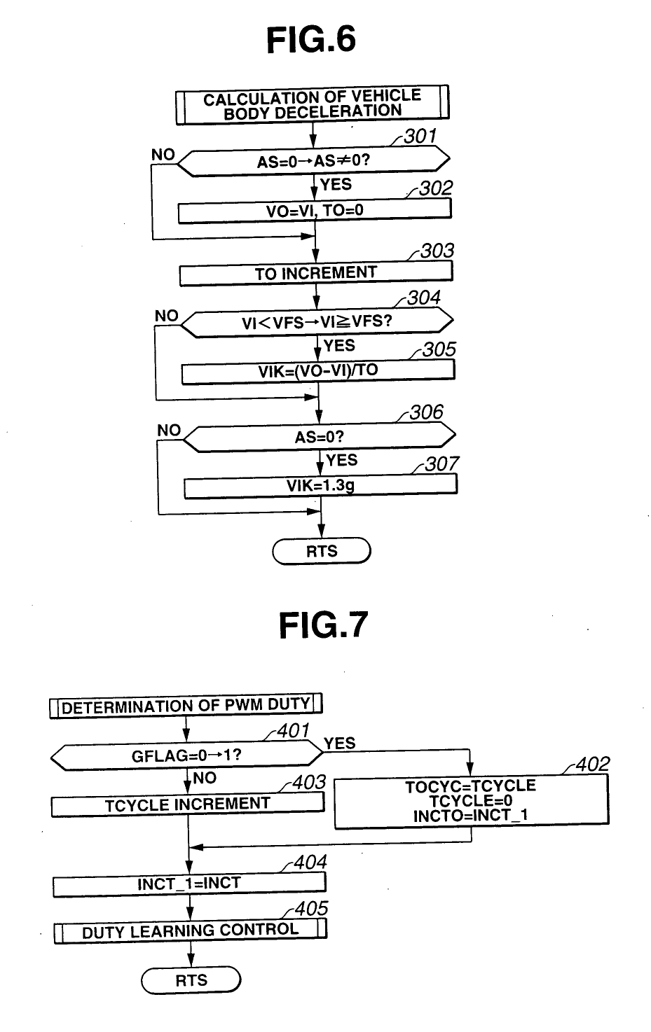

Step 102 following step 101 calculates a pseudo vehicle body speed VI in accordance with the wheel speeds VW determined at step 101. The calculation of pseudo vehicle body speed VI is shown more in detail in FIGS. 5 and 6.

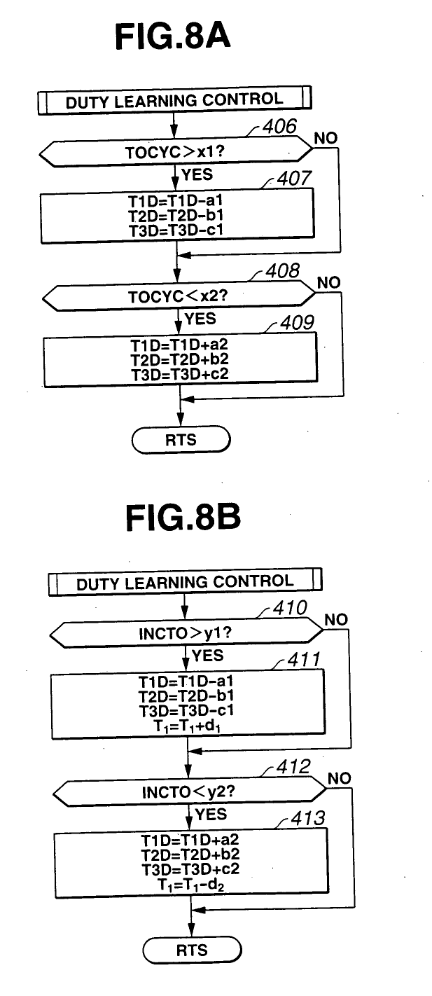

Step 103 determines a PWM duty as shown in FIG. 7 and FIGS. 8A and 8B.

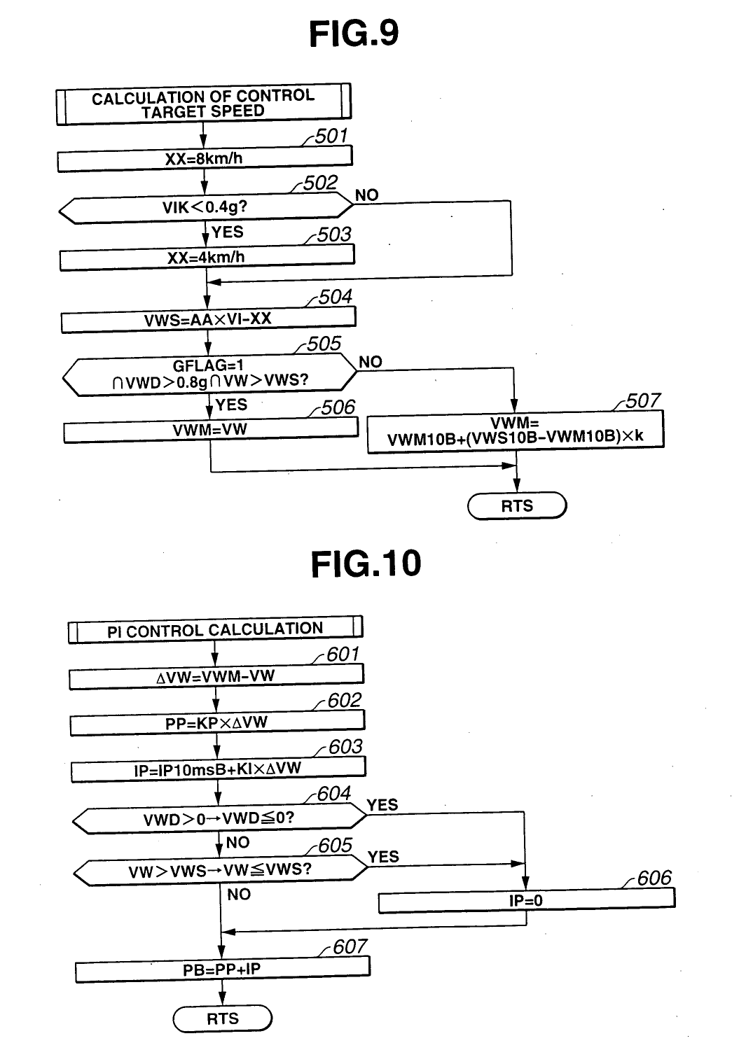

Step 104 calculates a control target speed VWM. FIG. 9 shows more in detail the calculation of control target speed VWM.

Step 105 performs a PI control process to determine a target brake fluid pressure PB. FIG. 10 shows more in detail the PI control process.

Step 106 examines whether or not the wheel speed VW of each wheel determined at step 101 is lower than an optimum slip rate level VWS which is a threshold to start the pressure decrease control, and at the same time a later-mentioned pressure increase flag ZFLAG is equal to one to indicate the pressure increase control. When VW<VWS and ZFLAG=1, and the answer of step 106 is YES, then the program proceeds from step 106, to step 108. In the case of NO, the program proceeds to step 107.

Step 108 performs a first setting operation to set, to A, an anti-skid timer AS indicating the execution of the anti-skid control (AS=A), a second setting operation to reset, to zero, a pressure hold timer THOJI indicating the execution of the pressure hold control (THOJI=0), and a third setting operation to set, to one, a pressure decrease flag GFLAG indicating the execution of the pressure decrease control (GFLAG=1). After step 108, the program proceeds to a step 110.

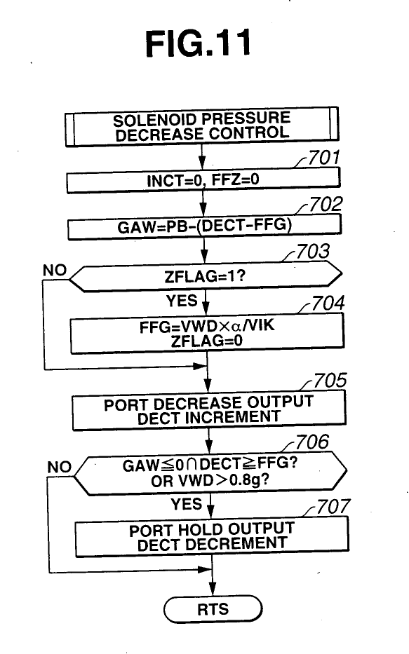

Step 110 performs the brake pressure decrease control. In the pressure decrease control, the opening degree of the pressure decrease valve 6 concerned is controlled to control the pressure decrease quantity by sending a duty signal to the pressure decrease valve 6. FIG. 11 shows more in detail the pressure decrease control.

Step 107 is reached from step 106 if VW≧VWS or ZFLAG=0, and hence the answer of step 106 is NO. Step 107 checks three conditions (first, second and third conditions) and thereby determines whether the brake pressure decrease control is desired. When any one or more of the three conditions is satisfied, then the program proceeds to step 108 to perform the pressure decrease control. When none of the three conditions are satisfied, then the program proceeds to step 109 to perform the pressure increase control or the pressure hold control.

The first condition of step 107 is met when a feedforward pressure decrease quantity FFG is greater than a pressure decrease timer DECT (that is, a feedforward pressure decrease control is ended). The second condition of step 107 is met when the pressure hold timer THOJI is greater than a hold time N₀ msec determined on the basis of the source voltage, and at the same time a quantity PB-(DECT-FFG) is greater than 8 msec (that is, after the No continuation of the hold control, there is still a demand for the pressure decrease control based on the PI control for some extent). The third condition of step 107 is met when the pressure hold timer THOJI is greater than N₁ msec, and at the same time PB−(DECT−FFG) is greater than 3 msec (that is, after the N₁ continuation of the pressure hold control, there is still a demand for the pressure decrease quantity based on the PI control though the demanded amount is small). PB is a current value of the target brake pressure, and DECT is an accumulated or integrated value of a pressure decrease operation time. If one of these conditions is met, and the answer of step 107 is YES, then the program assumes that the pressure decrease control is needed, and hence proceeds to step 108.

In this way, the pressure decrease control is performed when the pressure decrease counter DECT does not amount to the feedforward pressure decrease quantity FFG; when the target brake pressure PB exceeds 8 msec after the execution for N₀ msec of the pressure hold control after the execution of the later-mentioned feedforward pressure decrease; or when the target brake pressure PB exceeds 3 msec after the execution for N₁ msec of the pressure hold control after the execution of the feedforward pressure decrease. The target brake pressure PB is converted to a valve opening time of the pressure decrease valve 6 by multiplication of a layer-mentioned coefficient K.

Step 109 is for selection between the pressure increase control and the pressure hold control, by checking the following first, second and third conditions. From step 109, the program proceeds to step 112 for the pressure hold control when any one or more of the three conditions is satisfied; and to step 111 for the pressure increase control when none of the three conditions of step 109 are satisfied.

In this example, step 109 checks the first condition which is satisfied when FFZ≦INCT, and PB+(INCT−FFZ)<−3 msec (that is, a feedforward pressure increase is ended and at the same time a pressure increase control quantity based on the PI control is small). Step 109 further checks the second condition which is satisfied when the pressure hold control timer THOJI is smaller than a time N₂ msec (THOJI<N2) (that is, the pressure hold control is not continued for N₂ msec). Step 109 further checks the third condition which is satisfied when GFLAG=1, and VWD>0 g (that is, the wheel acceleration is positive after the pressure decrease control. FFZ is a feedforward pressure increase quantity, as mentioned later, and INCT is a pressure increase timer resulting from integration of the FFX≦INCT, and PB+(INCT−FFZ)<−3 msec (that is, a feedforward pressure increase is finished and at the same time a pressure increase control quantity based on the PI control is small). FFZ is a later-mentioned feedforward pressure increase quantity, and INCT is a pressure increase timer which is an accumulated or integrated value of the pressure increase control time.

In this way, the pressure increase control is performed when the pressure increase counter INCT does not amount to the feedforward pressure increase quantity FFZ, and the demanded pressure increased quantity based on the PI control is great (greater then −3 msec) after the end of the feedforward pressure increase control; after the pressure hold control for N₂ msec is performed or when the wheel acceleration VWD is negative in the state in which the pressure decrease flag GFLAG is equal to one.

The third condition to start the pressure increase control is based on the following consideration. When the wheel speed VW increases after an end of the pressure decrease control, the wheel speed VW becomes closer to the pseudo vehicle body speed VI. Because the pseudo vehicle body speed VI is in a decelerating state, the vehicle acceleration VWD becomes negative after the wheel speed VW reaches the pseudo body speed VI. This is one condition to start the pressure increase control.

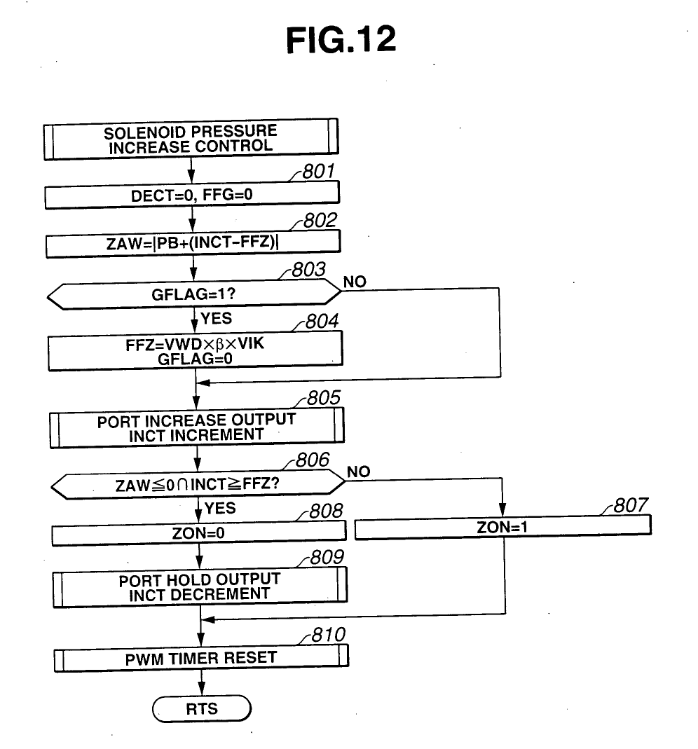

Step 111 performs the pressure increase control, as shown in FIG. 12.

After step 111, step 113 sets the pressure increase flag ZFLAG to one (ZFLAG=1), and resets the pressure hold timer THOJI to zero (THOJI=0).

Step S112 performs the pressure hold control when the answer of step 109 is affirmative.

After 112, step S114 increments (increases by one) the pressure hold timer THOJI.

After 114, step 115 checks whether a period of 10 msec has elapsed. The program repeats step S115 if the elapsed time is smaller 10 msec (NO), and proceeds to next step 116 if the elapsed time is equal to or greater than 10 msec (YES).

Step 116 checks whether a period of 10 msec has elapsed. When step 116 is reached after the pressure decrease control of step 110 or after the pressure increase control of step 111 (and step 113), the program proceeds to 117 if the elapsed time is smaller 10 msec (NO), and proceeds to step 119 if the elapsed time is equal to or greater than 10 msec (YES). When step 116 is reached after the pressure hold control of step 112 (and steps 114 and 115), the program proceeds immediately to step 119 since 10 msec has already elapsed.

Step 117 checks whether a period of 1 msec has elapsed. After the elapse of 1 msec, the program proceeds to step 118.

Step 118 examines whether GFLAG=1. The program returns to step 110 when the pressure decrease control is in progress and hence GFLAG=1. The program proceeds to step 111 when the pressure increase control is in progress, and hence GFLAG≠1.

In the case of the pressure decrease or increase control, therefore, the control unit 12 performs step 110 or 111 every 1 msec, and proceeds to step 119 after the elapse of 10 msec. At step 119, the control unit 12 selects a greater one of zero and a difference resulting from subtraction of one from the anti-skid timer AS, and sets AS to the selected greater one. Thereafter, the control unit 12 returns to step 101.

FIG. 5 shows the pseudo vehicle body speed calculating process of step 102.

Step 201 saves a maximum (or a highest value) among the four wheel speeds, as a control wheel speed VFS. After step 201, the program proceeds to step 202.

Step 202 determines whether the anti-skid timer AS is equal to zero or not, to determine whether the pressure decrease control is finished. The program proceeds to step 203 when AS=0 before the pressure decrease, and to step 204 when AS≠0 after the pressure decrease.

Before the pressure decrease, step 203 sets the control wheel speed VFS equal to a maximum among the wheel speeds VWRR and VWRL of the non-driven rear wheels, and then proceeds to step 204.

Step 204 examines whether pseudo vehicle body speed VI is equal to or higher than control wheel speed VFS, or not. In the case of YES (VI≧VFS), the program proceeds to step 205 to calculate pseudo vehicle body speed VI by using a vehicle body deceleration VIK, and otherwise proceeds to step 206 to calculate pseudo vehicle body speed VI without using vehicle body deceleration VIK.

Step 205 determines pseudo vehicle body speed VI based on vehicle body deceleration VIK by using the following equation.
VI=VI−(VIK)×K

Step 206 sets a constant x used in calculation equal to 2 km/h (x=2 km/h).

Step 207 checks again whether anti-skid timer AS is equal to zero or not. In the case of YES (AS=0) indicating non-execution of the pressure decrease control, the program proceeds to step 208, decreases the constant x by setting the constant x equal to 0.1 km/h at step 208, and proceeds to step 209. In the case of NO (AS≠0), the program proceeds from step 207 directly to step 209.

Step 209 determines pseudo vehicle body speed VI by the following equation.
VI=VI+x
When control wheel speed VFS exceeds pseudo body speed VI, indicating an accelerating state, pseudo body speed VI is increased by addition of constant x. When, on the other hand, pseudo body speed VI is higher than control wheel speed VFS, indicating a decelerating state, pseudo body speed VI is determined on the basis of vehicle body deceleration VIK

After step 205 or step 209, step 210 calculates the vehicle body deceleration VIK in accordance with pseudo vehicle body speed VI, as shown in FIG. 6.

FIG. 6 shows the calculation of the vehicle body deceleration VIK in step 210 of FIG. 5.

Step 301 examines whether the anti-skid timer AS is changed from a zero state (AS=0) to a nonzero state (AS≠0) to detect a start of the anti-skid control. From step 301, the program proceeds to step 302 at the start of the anti-skid control (AS=0→AS≠0), and directly to step 303 when a start of the anti-skid control is not detected (AS=0).

Step 302 saves a then-existing value of pseudo body speed VI as a calculation reference speed VO (VO=VI), and resets a calculation reference timer TO to zero (TO=0). After step S302, the program proceeds to step 303. Step 303 increments (increases by one) the calculation reference timer TO, and then transfers control to step 304.

Step 304 checks an inequality relation between control pseudo body speed VI and control wheel speed VFS, and determines whether the relation is changed from the state in which VI<VFS to the state in which VI≧VFS. Thus, step 304 determines whether the wheel speed VW is increased by the pressure decrease control, and restored to the pseudo vehicle body speed VI, by detecting a spin-up point at which the direction of pseudo body speed VI is changed from an upward direction to a downward direction. When a spin-up point is detected, and hence the answer of step 304 is YES (VI<VFS→VI≧VFS), the program proceeds to step 305, and otherwise the program proceeds directly to step 306.

Step 305 determines the vehicle body deceleration VIK by the following equation, from the then existing value of pseudo body speed VI, the calculation reference speed VO at the time of start of the anti-skid brake control, and the calculation reference timer TO set to start the measurement from the start of the anti-skid brake control.
VIK=(VO−VI)/TO

Step 306 determines whether anti-skid timer AS is equal to zero or not, and step 307 sets body deceleration VIK equal to 1.3 g when AS=0. In the first cycle of the anti-skid control, the control system is unable to calculate the vehicle body deceleration VIK at step 305 since the wheel speed VW is lower than the actual vehicle body speed, and there is no spin-up point. Accordingly, this control system uses, as VIK, a fixed value corresponding to a value in the case of braking on a high μ road surface until a spin-up point is detected.

FIG. 7 shows the process for determining the PWM duty, performed at step 103 of FIG. 4.

Step 401 examines whether the pressure decrease flag GFLAG is changed from zero to one, to detect a start of the pressure decrease. From step 401, the program proceeds to step 402 in the case of detection of change of GFLAG (YES of step 401), and to step 403 when no change is detected (NO of step 401).

Step 402 sets a previous cycle period TOCYC equal to TCYCLE (TOCYC=TCYCLE); clears TCYCLE (TCYCLE=0); and substitutes the pressure increase time INCT into a previous pressure increase time INCTO. Then, control is transferred to step 404.

Step 403 measures the period by incrementing (increasing by one) the control cycle period timer TCYCLE, and then transfers control to step 404.

Step 404 substitutes a current value of INCT into the previous total pressure increase time INCTO 10 msec before, and transfers control to step 405.

Step 405 performs a duty learning control as shown more in detail in FIGS. 8A and 8B.

FIGS. 8A and 8B show two duty learning control processes performed at step 405 of FIG. 7. The duty learning control process of FIG. 8A is for the cycle time, and the learning control process of FIG. 8B is for the total pressure increase time.

In the flowchart of FIG. 8A for the duty learning control process with respect to the cycle time, step 406 compares TOCYC with a predetermined threshold value x1 (a value in the range of 300˜500 ms). From step 406, the program proceeds to step 407 when TOCYC>x1, and to step 408 when TOCYC≦x1.

Step 407 determines a first (starting) ON duty T1D by subtracting a1(%) from a previous value of the first ON duty T1D (T1D=T1D−a1); determines a second (intermediate) ON duty T2D by subtracting b1(%) from a previous value of the second ON duty T2D (T2D=T2D−b1); and determines a third (ending) ON duty T3D by subtracting c1(%) from a previous value of the final ON duty T3D (T3D=T3D−c1). By so doing at step 407, the control system increases the pressure increase quantity by decreasing the ON duty and decreasing the average current, and then proceeds to step 508. (T1D, T2D AND T3D will be explained later.)

Step 408 compares TOCYC with a predetermined threshold value x2 (a value in the range of 50˜200 ms) which is smaller than x1. From step 408, the program proceeds to step 409 when TOCYC<x2, and terminates the process of FIG. 8A when TOCYC≧x2.

Step 409 increases the first ON duty T1D by a2(%) (T1D=T1D+a2); increases the second ON duty T2D by b2(%) (T2D=T2D+b2); and increases the third ON duty T3D by c2(%) (T3D=T3D+c2). By so doing at step 409, the control system decreases the pressure increase quantity by increasing the ON duty and increasing the average current, and then terminates the process of FIG. 8A.

In the flowchart of FIG. 8B for the duty learning control process with respect to the total pressure increase time, step 410 compares INCTO with a predetermined threshold value y1 (a value in the range of 20˜50 ms). From step 410, the program proceeds to step 411 when INCTO>y1, and to step 412 when INCTO≦y1.

Step 411 determines the first (starting) ON duty T1D by subtracting a1(%) from the previous value of the first ON duty T1D (T1D=T1D−a1); determines the second (intermediate) ON duty T2D by subtracting b1(%) from the previous value of the second ON duty T2D (T2D=T2D−b1); and determines the third (ending) ON duty T3D by subtracting c1(%) from the previous value of the third ON duty T3D (T3D=T3D−c1). By so doing at step 411, the control system increases the pressure increase quantity by decreasing the ON duty and decreasing the average current, and then proceeds to step 412. Moreover, step 411 increases a valve opening time T1 by d1(ms), by adding d1 to the previous value of T1 (T1=T1+d1). From step 411, the program proceeds to step 412.

Step 412 compares INCTO with a predetermined threshold value y2 (a value in the range of 5˜15 ms) which is smaller than y1. From step 412, the program proceeds to step 413 when INCTO<y2, and terminates the process of FIG. 8B when INCTO≧y2.

Step 413 increases the first ON duty T1D by a2(%) (T1D=T1D+a2); increases the second ON duty T2D by b2(%) (T2D=T2D+b2); and increases the third ON duty T3D by c2(%) (T3D=T3D+c2). By so doing at step 413, the control system decreases the pressure increase quantity by increasing the ON duty and increasing the average current. Moreover, step 413 decreases the valve opening time T1 by d2(ms), by subtracting d2 from the previous value of T1. Then, the process of FIG. 8B ends. In these examples, a1-d2 are predetermined constants.

FIG. 9 shows the calculation of the control target speed of step 104 shown in FIG. 4.

Step 501 sets constant XX to 8 km/h (XX=8 km/h), and transfer control to step 502.

Step 502 examines whether the vehicle body deceleration VIK is lower than a predetermined value (0.4 g)(VIK<0.4 g). In the case of YES (the deceleration is not yet increased sufficiently), the program proceeds from step 502 to step 503, and otherwise proceeds to step 504. Step 503 sets constant XX to 4 km/h, and transfers control to step 504.

Step 504 calculates the optimum slip rate speed VWS by the use of the following equation from pseudo vehicle body speed VI and thereafter transfers control to step 505.
VWS=AA×VI−XX
The optimum slip rate speed VWS represents the wheel speed capable of providing an optimum slip rate desirable for decreasing the pseudo vehicle body speed efficiently.

Step 505 checks whether the pressure decrease flag GFLAG is set to one, the wheel acceleration VWD exceeds a predetermined value F (0.8 g), and at the same time the wheel speed VW exceeds the control target speed VWS. In the case of YES (GFLAG=1, VWD>0.8 and VW>VWS), the program proceeds to step 506, and sets target wheel speed VWM to wheel speed (VWM=VW). In the case of NO, the program proceeds to step 507. Step 507 determines the target control wheel speed VWM with a low-pass filter of a first order lag, according to the following equation.
VWM=VWM10B+(VWS10B−VWM10B)×k
In this equation VWM10B is a value of VWM 10 msec before, and VWS10B is a value of VWS 10 msec before.

Thus, when the wheel speed is restored toward the actual vehicle speed with the wheel acceleration VWD higher than 0.8 g after the execution of the pressure decrease control, the target wheel speed VWM is set equal to the wheel speed (VWM=VW). When the wheel speed VW becomes close to the actual vehicle speed (near the spin-up point) where the pressure increase control is required, the target wheel speed VWM is converged to the optimum slip rate speed VWS with a first order lag.

FIG. 10 shows the PI control process of step 105 shown in FIG. 4.

Step 601 determines a deviation AVW between target wheel speed VWM and wheel speed VW by using the following equation.
ΔVW=VWM−VW

Step 602 determines a deviation pressure time (proportional term) PP by multiplying the deviation ΔVW by a pressure proportion gain KP, and thereby converting the deviation ΔVW to a time corresponding to the brake fluid pressure.
PP=KP×ΔVW

Step 603 determines an integral pressure time (integral term) IP for the PI control by using the following equation.
IP=IP10msB+KI×ΔVW (KI: Integral Gain)
In this equation IP10msB is a previous value of IP obtained one cycle (10 ms) before.

Step 604 checks the wheel acceleration VWD to determine whether the wheel acceleration is changed from the positive state in which VWD>0, to the non-positive state in which VWD≦0. From step 604, the program proceeds to step 606 in the case of YES (the wheel acceleration is changed from the positive state in which VWD>0, to the non-positive state in which VWD≦0); and otherwise to step 605.

Step 605 checks the wheel speed VW to determine whether the wheel speed is changed from the state in which the wheel speed VW is higher than the optimum slip rate speed VWS, to the state in which VW≦VWS. From step 605, the program proceeds to step 606 in the case of YES (the wheel speed is changed from the state in which VW>VWS to the state in which VW≦VWS); and otherwise to step 607.

Step 606 resets the integral pressure time IP to zero (IP=0). Thus, the integral pressure time IP is cleared to zero just before the pressure decrease control or the pressure increase control is started.

Step 607 determines the target fluid pressure PB by the following equation and then terminates this flow.
PB=PP+IP
In this case, the pressure is increased when PB is negative, and the pressure is decreased when PB is positive.

FIG. 11 shows the solenoid pressure decrease control of step 110 of FIG. 4.

Step 701 resets the pressure increase timer INCT to zero (INCT=0), and resets the feedback pressure increase quantity FFZ to zero (FFZ=0).

Next step 702 determines a pressure decrease time GAW by using the following equation.
GAW=PB−(DECT−FFG)
When the pressure decrease control is stated and the feedforward control is performed, PB is equal to zero since the deviation ΔVW is equal to zero.

Step 703 examines whether pressure increase flag ZFLAG is set to one or not, to detect a first time of the pressure decrease control. From step 703, the program proceeds to step 704 in the case of the first cycle of the pressure decrease control (ZFLAG=1), and proceeds to step 705 without performing step 704 when ZFLAG≠1.

Step 704 determines feedforward pressure decrease quantity FFG by the following equation.
FFG=VWD×α/VIK (α: Coefficient)
Moreover, step 704 resets pressure increase flag ZFLAG to zero. Thus, the pressure decrease quantity in the first cycle is determined in accordance with wheel acceleration with respect to body deceleration VIK, and the pressure decrease quantity thus determined is referred to as the feedforward pressure decrease quantity in this specification. When the wheel deceleration VWD is great as compared to the body deceleration VIK, the control system considers that the locking tendency is strong, and increases the feedforward pressure decrease quantity. When the wheel deceleration VWD is close to the body deceleration VIK (FFG is close to one, that is), the control system considers that the locking tendency is weak, and decreases the feedforward pressure decrease quantity.

Step 705 increments (increases by one) a port pressure decrease output DECT.

Step 706 examines a first condition which is satisfied when the pressure decrease time GAW is equal to or smaller than zero, and at the same time the pressure decrease timer DECT is equal to or greater than the feedforward pressure decrease quantity FFG; and a second condition which is satisfied when the wheel acceleration VWD is higher than 0.8 g. When either of the first and second conditions is satisfied, the program proceeds to step 707, and step 707 decrements a port hold output DECT. When none of the first and second conditions is satisfied, then the control flow of FIG. 11 ends.

Thus, in the case of the pressure decrease control, the control system first outputs the pressure decrease quantity corresponding to the feedforward control calculated at the start of the pressure decrease control. Then, after the pressure decrease output, the control system terminates the pressure decrease control and starts the pressure hold output if the wheel acceleration VWD exceeds 0.8 g and the wheel speed is approaching the vehicle body speed.

FIG. 12 shows the solenoid pressure increase control of step 111 in FIG. 4.

Step 801 resets the pressure decrease counter DECT for measuring the time of the pressure decrease, to zero (DECT=0), and resets the feedback pressure decrease quantity FFG to zero (FFG=0).

Next step 802 determines the pressure increase time ZAW by using the following equation.
ZAW=|PB+(INCT−FFZ)|.

Step 803 examines whether pressure decrease flag GFLAG is set to one, or not, to detect a first time of the pressure increase control. In the case of YES (GFLAG=1) at the first time of the pressure increase control, the program proceeds to step 804. In the case of NO (GFLAG≠1), the program proceeds to step 805 directly without passing through step 804.

Step 804 determines the feedforward pressure increase quantity FFZ by the following equation.
FFZ=VWD×β×VIK
Moreover, step 804 resets pressure decrease flag GFLAG to zero (GFLAG=0), and then transfers control to step 805. Thus, the pressure increase quantity of the first time is determined on the basis of wheel acceleration VWD. This pressure increase quantity is referred to as feedforward pressure increase quantity in this specification. In this equation, β corresponds to a restoring acceleration. In this case, the restoring acceleration is great and the pressure decrease is excessive, so that the vehicle body deceleration VIK is multiplied to prevent an excessive pressure decrease.

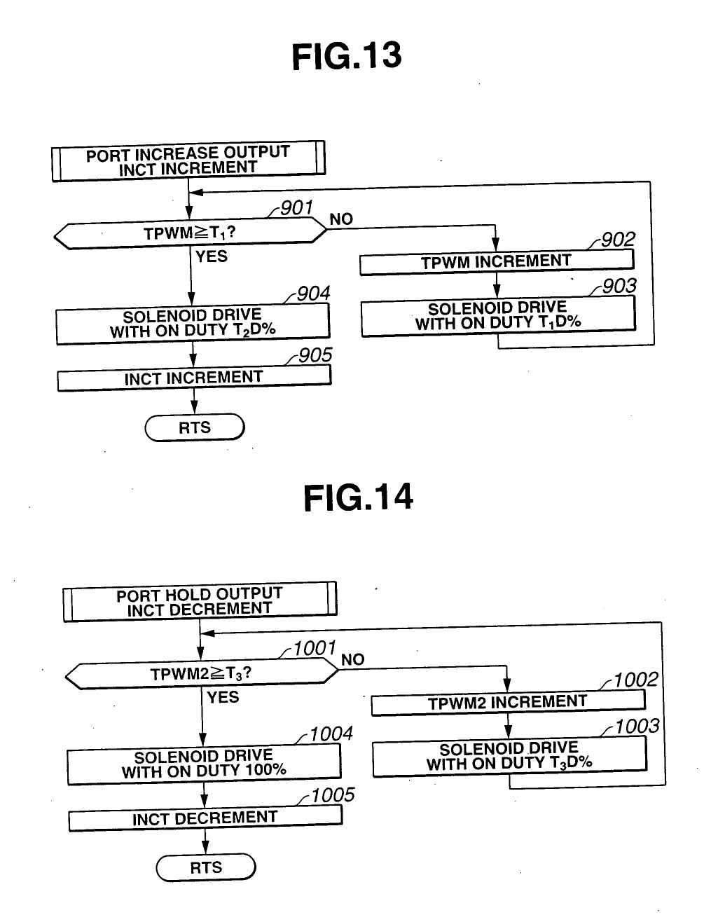

Step 805 increments (increases by one) a port pressure increase output INCT, as shown in FIG. 13. Thereafter, the program proceeds to step 806.

Step 806 examines whether the pressure increase time ZAW is equal to or smaller than zero (ZAW≦0), and at the same time the pressure increase timer INCT is equal to or greater than the feedforward pressure increase quantity FFZ (INCT≧FFZ). In the case of YES, the program proceeds to step 808. In the case of NO, the pressure increase is continued and the program proceeds to step 807.

Step 807 sets a pressure increase on flag ZON to one, and the program proceeds to step 810.

Step 808 clears the pressure increase on flag ZON to zero to terminate the pressure increase, and then transfers control to step 809.

Step 809 decrements port hold output INCT, as shown in FIG. 14, and transfers control to step 810.

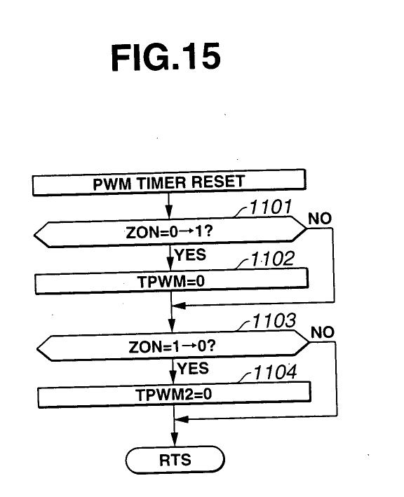

Step 810 resets a PWM timer, as shown in FIG. 15.

FIG. 13 shows the operation of port pressure increase output INCT increment in step 805 of FIG. 12.

Step 901 examines whether a pressure increase on PWM timer TPWM is equal to or greater than a time T1, and transfers control to step 904 when TPWM≧T1, and to step 902 when TPWM<T1.

Step 902 increments (increases by one) the pressure increase on PWM timer TPWM, and transfers control to step 903.

Step 903 drives the solenoid with the ON duty T1D %, and the program returns to step 901.

When the pressure increase on PWM timer TPWM is equal to or greater than T1, step 904 drives the solenoid with the on duty T2D %, and transfers control to step 905.

Step 905 increments (increases by one) INCT, and then the process of FIG. 13 ends.

FIG. 14 shows the operation of port pressure hold output INCT decrement in step 809 of FIG. 12.

Step 1001 examines whether a pressure hold on PWM timer TPWM2 is equal to or greater than a time T3, and transfers control to step 1004 when TPWM2≧T3, and to step 1002 when TPWM2<T3.

Step 1002 increments (increases by one) the pressure hold on PWM timer TPWM2, and transfers control to step 1003.

Step 1003 drives the solenoid with the ON duty T3D %, and the program returns to step 1001.

When the pressure hold on PWM timer TPWM2 is equal to or greater than T3, step 1004 drives the solenoid with the on duty 100%, and transfers control to step 1005.

Step 1005 decrements (decreases by one) INCT, and then the process of FIG. 14 ends.

FIG. 15 shows the PWM timer reset process of step 810 in FIG. 12.

Step 1101 examines whether the pressure increase on flag ZON is changed from zero to one. From step 1101, the program proceeds to step 1102 when the pressure increase on flag ZON is changed from zero to one, and directly to step 1103 when the pressure increase on flag ZON is not changed.

Step 1102 resets the pressure increase on PWM timer TPWM to zero, and transfers control to step 1103.

Step 1103 examines whether the pressure increase on flag ZON is changed from one to zero. From step 1103, the program proceeds to step 1104 when the pressure increase on flag ZON is changed from one to zero, and terminates the flow of FIG. 15 when the pressure increase on flag ZON is not changed.

Step 1104 resets the pressure hold on PWM timer TPWM2 to zero, and the program ends.

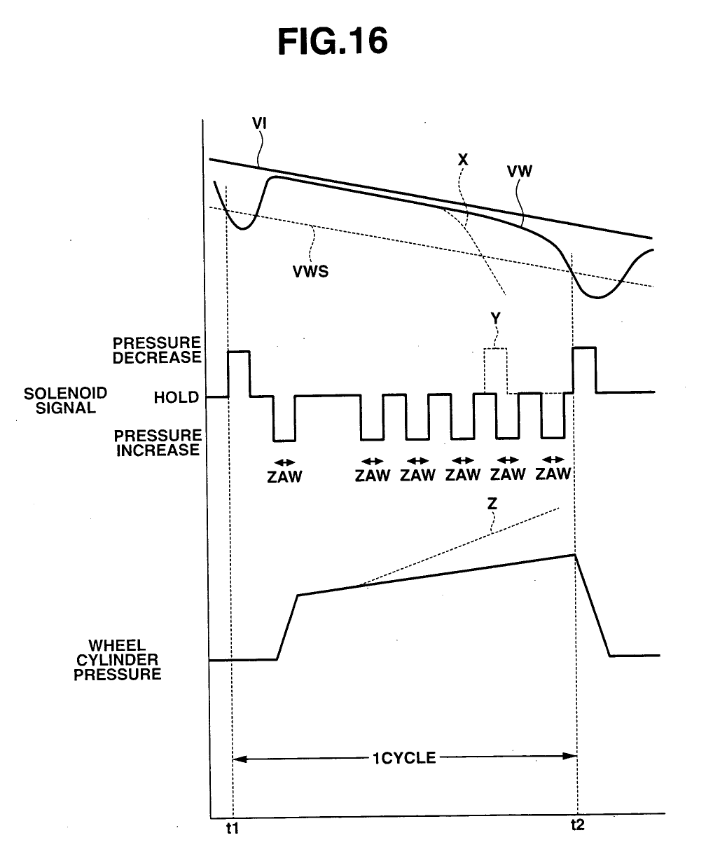

FIG. 16 is a time chart showing a relationship between the solenoid signal to each pressure increase valve 5 and the control cycle time in the anti-skid brake control. As shown in FIG. 16, wheel speed VW converges to optimum slip rate speed VWS as pseudo vehicle body speed VI decreases by the effect of braking.

When the wheel speed VW becomes lower than optimum slip rate speed VWS in the state in which the anti-skid brake control is not yet started, the control system starts the pressure decrease control at an instant to. Then, the control system brakes the wheel so as to prevent wheel locking by repeating the pressure increase and the pressure hold.

When the wheel speed VW becomes lower than VWS again at an instant t2, the control system performs the pressure decrease control again. In this case, one cycle is from the start of the previous pressure decrease operation at to (the timing of a first pressure decrease command), to the start of the current pressure decrease operation at t2 (the timing of a second pressure decrease command).

When the wheel cylinder pressure is increased excessively as shown by a broken line Z in FIG. 16 for reason of nonuniformity in the pressure increase characteristic, the wheel speed VW decreases as shown by a broken line X and the second pressure decrease operation is started earlier as shown by a broken line Y in FIG. 16.

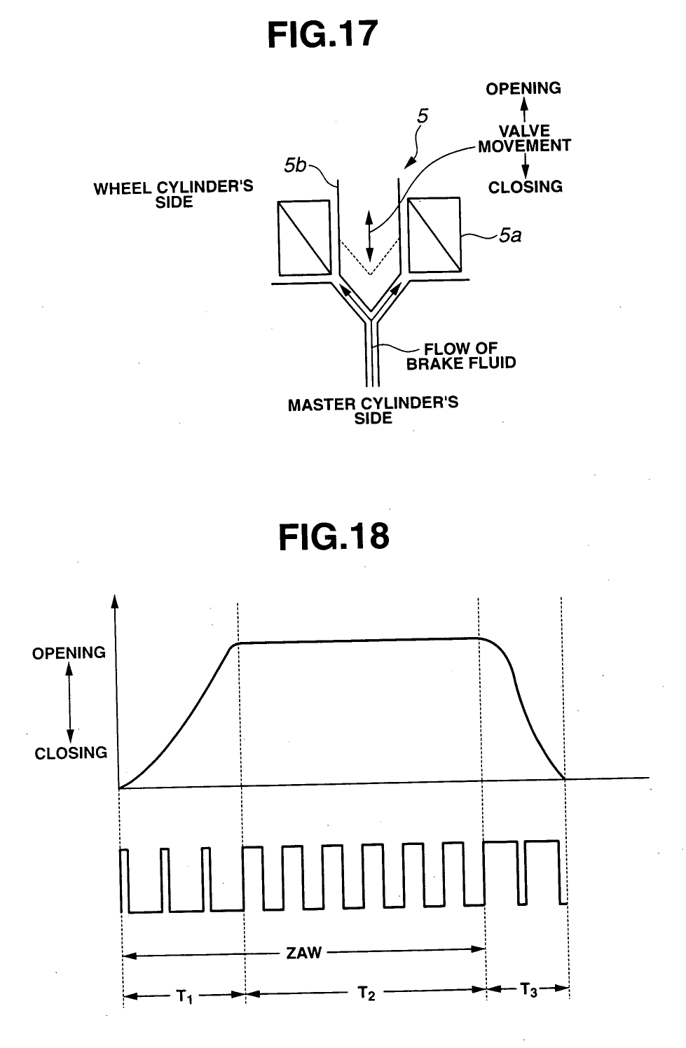

FIG. 17 schematically shows the structure of pressure increase valves 5. By the relation between an attractive force produced by a solenoid 5a and a pressure difference between the master cylinder pressure and the wheel cylinder pressure, a spool 5b moves up (in the opening direction) and down (in the closing direction), and determines the valve opening degree. Nonuniformity in the response characteristic of the solenoid 5a could cause an excessive increase of the wheel cylinder pressure as shown by the broken line Z in FIG. 6. By the excessive increase of the wheel cylinder pressure, the wheel speed is decreased earlier as shown by the broken line X in FIG. 16, and hence the timing to start the next pressure decrease operation is advanced as shown in FIG. 16 by the broken line Y in the form of a rectangular pulse.

Such advance of the pressure decrease timing could cause problems. First, the reservoir is liable to become full soon, to such a level to impede the subsequent pressure decrease control (not to gain a sufficient pressure decrease quantity). Second, the operating noise of pressure increase valve 5 is increased. To avoid these problems, it is desirable to hold the cycle time from a start of one pressure decrease operation to a start of a next pressure decrease operation more or less uniform.

Therefore, the control system according to the embodiment is arranged to calculate the cycle time and the total time of pressure increase pulses (the sum of values of ZAW) within one cycle from the start of one pressure decrease operation to the start of a next pressure decrease operation, and to vary the PWM duty in the following manner.

FIG. 18 is a view for illustrating relation between the PWM duty control and movement of pressure increase valve 5. In FIG. 18, T1 is a time (period) to open the increase valve 5 from the closed state. T2 is a time (period) of an actual pressure increase operation. T3 is a time (period) to close the pressure increase valve 5 from the open state.

In response to a change of pressure decrease flag GFLAG from zero to one, the control unit 12 proceeds from step 401 to step 402 in FIG. 7. At step 402, control unit 12 sets TCYCLE in the previous cycle period TOCYC, and substitutes the previous total pressure increase time INCT_1 ascertained 10 ms before, into INCTO. Thereafter, control unit 12 proceeds to step 404. At step 404, control unit 12 substitutes the current INCT into the previous total pressure increase time INCT_1 before 10 ms, and proceeds to step 405. At step 405, control unit 12 determines the starting on duty T1D %, the intermediate on duty T2D %, and the ending on duty T3D % from the previous cycle time period TOCYC according to steps 406-409, or from the previous total pressure increase time INCTO according to steps 410-413.

When a transistor is switched on for pressure increase valve 5, a turning off operation does not take place immediately because there is some delay in response by influence of a diode, so that it takes time for the pressure increase valve 5 to open. Accordingly, in this example, there is provided the starting on duty T1D % to which little or no electric current is supplied from a closed state of pressure increase valve 5 to an open state.

After the T1 period, the solenoid is driven with the intermediate on duty T2D %. T2 is calculated in accordance with ZAW (time for actually increasing the pressure). The sum of T2 and T1 corresponds to the pressure increase time ZAW (one pressure increase cycle or one pressure increase operation in FIG. 16).

During the T3 period, pressure increase valve 5 is closed with the ending duty T3D %. In this example, T3D is 35% of a desired PWM duty. Abrupt closing of pressure increase valve 5 could cause noises and vibrations. Therefore, the control unit 12 brings the pressure increase valve 5 gradually from the open state to the closed state during the T3 period.

The brake control system according to this embodiment determines the PWM duty ratio by using the total pressure increase time INCTO, or the cycle time TOCYC obtained as a result of calculation on sensed wheel speeds for the anti-skid brake control, instead of using a sensed wheel cylinder pressure. Therefore, the PWM duty ratio is not influenced by nonuniformity or errors in wheel cylinder pressures. Therefore, the brake control system can control the pressure increase and decrease operations adequately in accordance with actual wheel motion, and thereby take in the road surface condition properly. Moreover, the control system according to this embodiment employs the learning control and calculates the results with addition or subtraction or algebraic sum such as T1−a1, T2−b1, T3−c1, T1+a2, T2+b2 and T3+c2 as shown in FIGS. 8A and 8B. Therefore, it is possible to reduce the control load as compared to a system employing map data. The use of the cycle time or the total pressure increase time for the duty ratio control makes a contribution to improvement in the accuracy in controlling the cycle time or the pressure increase time and hence the accuracy in controlling the brake pressure. Accordingly, the brake system can prevent deficient pressure decrease due to a full state of a reservoir caused by excessive pressure increase and a decrease of control cycle.

FIG. 1 illustrates a basic arrangement of a brake control system according to this embodiment of the present invention. The brake control system shown in FIG. 1 includes a hydraulic brake actuator in the form of a wheel cylinder “a”, a brake fluid pressure modulator including at least one solenoid valve “b” to regulate a brake fluid pressure supplied to the brake actuator, a vehicle condition sensor “c”, and a brake control section which, in the example of FIG. 1, includes a controller section “d” to determine a solenoid valve drive time in accordance with the condition sensed by the condition sensor, and a driver section “e” to drive the solenoid valve to achieve the solenoid valve drive time. The driver section “e” can serve as means for driving the solenoid valve, and may include a drive circuit “f” to produce a solenoid drive signal for the solenoid valve. The controller section “d” of brake control section in the example of FIG. 1 monitors at least one of a cycle time of a cycle between two consecutive pressure decrease operations of the solenoid valve and a pressure increase time which is a length of time used to control the solenoid valve in the pressure increase mode within the cycle, and to determine a solenoid valve drive time corresponding to the pressure increase mode in a next cycle, in accordance with at least one of the cycle time and the pressure increase time.

The brake control section may be configured to control the brake fluid pressure by varying a duty ratio (or duty factor) of a PWM (or PDM) control signal to drive the solenoid valve. When the pressure increase time is longer than a predetermined first threshold time, the brake control section may decrease the on-duty. Thus, the control system can prevent an insufficient pressure increase on a high μ road by increasing the pressure increase quantity of the solenoid valve. When the pressure increase time is shorter than a predetermined second threshold, the brake control section may increase the on-duty. Thus, the control system can prevent an excessive pressure increase on a low μ road by decreasing the pressure increase quantity of the solenoid valve. Moreover, the brake control section may be configured to vary the on duty ratio by an arithmetic operation of addition or subtraction of a predetermined value to or from a previous value of the on duty. In this case, the control system can perform stable control operation without using map data, and reduce the load on a CPU of the brake control section. Moreover, the brake control section can perform the adding or subtracting operation by a learning control without using map data, and thereby provide control performance adequate to the actual situation despite influence of unexpected disturbance.

The present invention can be applied to various brake pressure control apparatus besides the anti-skid brake control apparatus. For example, the brake control system according to the present invention may be a control system for restraining drive wheel slip, or may be a control system for producing a yawing moment by applying braking forces on wheels in a direction to restrain undesired oversteer condition or understeer condition of a vehicle.

The brake control system according to the illustrated embodiment can control the pressure increase quantity accurately so as to remedy excess or deficiency in the pressure increase. Specifically, the brake control system is arranged to vary the duty for increasing the pressure in accordance with the time for the pressure increase in a previous cycle, instead of the number of pressure increase operations. In the anti-skid brake control, from the viewpoint of reduction of noises and vibrations, it is desirable to control the pressure increase quantity and the pressure decrease quantity properly, neither too-much nor too little, so as to cause a wheel speed to converge at a desired wheel speed to provide an optimum slip rate achieving both satisfactory braking performance and vehicle stability. In controlling the pressure increase quantity and decrease quantity by driving a solenoid valve with a drive signal having a controlled duty, the brake control system according to the embodiment is arranged to vary the duration of a single pressure increase operation (that is, the duration of one pulse for pressure increase) in accordance with the wheel speed, in order to reduce the noises and vibrations. For example, the PID control is used to regulate the pressure increase time (ZAW) of one pressure increase pulse so as to control the actual wheel speed toward the desired target speed. In this control in which the duration of each pressure increase operation or each pulse is variable, it is difficult to determine the pressure increase quantity accurately from the number of pressure increase operations or the number of pulses. Therefore, the pressure increase quantity might be controlled without sufficient information on whether the pressure increase control in the previous cycle is deficient or excessive. By contrast, the brake control system according to the illustrated embodiment is arranged to control the pressure increase quantity by using the pressure increase time which is the length of time used for the pressure increase. Therefore, the control system can control the pressure increase quantity properly in accordance with the time length of the pressure increase operation or operations.

This application is based on a prior Japanese Patent Application No. 2004-077114 filed on Mar. 17, 2004. The entire contents of this Japanese Patent Applications No. 2004-077114 are hereby incorporated by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

1. A brake control apparatus for a vehicle, comprising:
a hydraulic brake actuator to brake a wheel of the vehicle;
a solenoid valve to regulate a brake fluid pressure supplied to the brake actuator;
a condition sensor to sense a vehicle running condition; and
a brake control section to control the brake fluid pressure for the hydraulic brake actuator in a pressure decrease mode and a pressure increase mode in accordance with the vehicle running condition sensed by the condition sensor, by controlling the solenoid valve, the brake control section being configured
to monitor a cycle time of a cycle from a first pressure decrease operation to a second pressure decrease operation of the solenoid valve and
a pressure increase time spent to control the solenoid valve in the pressure increase mode within the cycle, and
to determine a solenoid valve drive time corresponding to the pressure increase mode in a next cycle, in accordance with the cycle time and the pressure increase time.

2. The brake control apparatus as claimed in claim 1, wherein the brake control section is arranged to control the solenoid valve by controlling a duty ratio in a manner of a PWM control, and to determine the solenoid valve drive time by varying the duty ratio.

3. The brake control apparatus as claimed in claim 2, wherein the pressure increase time is a total pressure increase time of pressure increase periods during which the solenoid valve is controlled in the pressure increase mode in one cycle.

4. The brake control apparatus as claimed in claim 3, wherein the brake control section is configured to decrease the duty ratio when the total pressure increase time increases.

5. The brake control apparatus as claimed in claim 4, wherein the brake control section is configured to increase the duty ratio when the total pressure increase time decreases.

6. The brake control apparatus as claimed in claim 4, wherein the brake control section is configured to decrease the duty ratio when the total pressure increase time is longer than a predetermined threshold.

7. The brake control apparatus as claimed in claim 4, wherein the brake control section is configured to increase the duty ratio when the total pressure increase time is shorter than a predetermined threshold.

8. The brake control apparatus as claimed in claim 4, wherein the brake control section is configured to vary the duty ratio by one of addition and subtraction of a predetermined value to a previous value of the duty ratio.

9. The brake control apparatus as claimed in claim 6, wherein the brake control section is configured to decrease the duty ratio when the total pressure increase time is longer than the predetermined threshold which is a first threshold, and to increase the duty ratio when the total pressure increase time is shorter than a second predetermined threshold

10. The brake control apparatus as claimed in claim 9, wherein the first threshold is greater than the second threshold.

11. The brake control apparatus as claimed in claim 2, wherein the brake control section includes a drive circuit to deliver a drive signal to the solenoid valve, and the brake control section is configured to determine the cycle time and the solenoid valve drive time by the drive signal.

12. The brake control apparatus as claimed in claim 11, wherein the condition sensor includes a wheel speed sensor to sense a wheel speed, and the brake control section is configured to vary a pressure increase period of each pressure increase operation in accordance with a variation of the wheel speed.

13. A brake control apparatus for a vehicle, comprising:
means for driving a solenoid valve to control a brake fluid pressure supplied to a wheel cylinder of the vehicle, and for thereby performing pressure decrease control and pressure increase control;
means for monitoring a pressure increase time which is a length of time of the pressure increase control in a cycle between two consecutive pressure decrease operations for the pressure decrease control; and
means for controlling a solenoid valve drive time to drive the solenoid valve to increase the brake fluid pressure, in accordance with the pressure increase time.

14. A brake control apparatus for a vehicle, comprising:
hydraulic brake actuators to brake wheels of the vehicle, respectively;
a modulator comprising solenoid valves to regulate brake fluid pressures supplied to the brake actuators, respectively;
a vehicle condition sensor to sense a vehicle running condition; and
a brake control section to drive each solenoid valve to perform pressure decrease control and pressure increase control to control the brake fluid pressure for each of the hydraulic brake actuators, in accordance with the vehicle running condition, and to control a pressure increase quantity of the pressure increase control in accordance with a cycle time of a cycle between two consecutive pressure decrease operations of the pressure decrease control.

15. A brake control apparatus for a vehicle, comprising:
a hydraulic brake actuator to brake a wheel of the vehicle;
a modulator comprising a solenoid valve to regulate a brake fluid pressure supplied to the brake actuator;
a vehicle condition sensor to sense a vehicle running condition; and
a brake control section to drive the solenoid valve with a PWM control signal to perform pressure increase operations in a cycle between two pressure decrease operations, in accordance with the vehicle running condition, to determine a pressure increase time which is a sum of time periods of the pressure increase operations in the cycle, and to vary a duty ratio of the PWM control signal in accordance with the pressure increase time.
